(19) United States
(12) Patent Application Publication
(10) Pub. No.: US 2008/0151710 A1
(43) Pub. Date: Jun. 26, 2008

(54) Optical disk apparatus and method for determining recording power for the same

(75) Inventors: Mitsunori Kobayashi, Chigasaki (JP); Toshio Shoji, Urayasu (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/895,526

(22) Filed: Aug. 24, 2007

(30) Foreign Application Priority Data
Dec. 25, 2006 (JP) 2006-348392

(51) Int. Cl. G11B 7/00

(52) U.S. Cl. 369/47.5

(57) ABSTRACT

In an optical disk apparatus and a method for determining the recording power for the same, for determining the optimum value of a laser power when recording data onto a high density optical disk, a test signal is recorded with changing the recording power Pw while fixing an erasing power Pe. Reproduction is made on the signal recorded so as to obtain a “β” value indicative of asymmetry of the reproduction signal to each the recording power. In this instance, the “β” value, or the optimal recording power Pwo is determined, with utilizing an area or region, being called APC region, which is provided in a part of the recording regions, which are divided into a large number thereof, each being made of a predetermined information recording unit (RUB), being unique to that disk, and further equalization thereof. Herein, the erasing power Pe to be fixed is determined from a result of measurement on a modulation factor, “M” value while recoding another test signal. Or, it may be determined in accordance with strategy information, which is determined for that optical disk in advance. Or, the erasing power Pe may be determined Pe [symbol] 0, irrespective of the optical disks.

### BACKGROUND OF THE INVENTION

The present invention relates to an optical disk apparatus for recording data onto a disc-like information recording medium, such as, an optical disk, and in particular, it relates to an optical disk apparatus adjusting the recording power of a laser beam, optimally, and also a method for determining the recording power for the same.

Conventionally, when recording data on an optical disk, for the purpose of obtaining sufficient recording quality for each of optical disks, an optimum recording power of the laser beam is obtained by executing a test recording thereon, and then recoding is conducted on the data with that optimum recording power obtained. Hereinafter, such a step is called by “OPC (Optimum Power Control)”. In that instance, according to the conventional technology, various kinds of methods are implemented and/or proposed, as parameters for estimating the recording quality. For example, for CD and/or DVD disks, there is applied a method of using asymmetry of signals recorded (“β” value) as an estimation index thereof (i.e., a “β” method). Also for the Blu-ray disk (“BD”) of high density and large capacity, so-called a “κ” method is recommended, i.e., a method for obtaining the optimum value through linear approximation of changes, with using modulation factor, as the estimation index thereof (in more details, the “κ” method is recommended for BD-RE, while the “κ” method or the “β” method for BD-R). However, parameters for determining the recording condition under each of those conditions are stored in a portion thereof, for each of the optical disks, in the form of control data, for example.

Through improvement of those methods, there is proposed a method, for determining the optimum condition at high accuracy. For example, in the following Patent Document 1 is disclosed a method for determining the recording power upon basis of a value relating to reflectivity and the “β” value, which are obtained from the optical disk, as an improvement of the “β” method. Also, in the following Patent Document 2 is disclosed a method, as an improvement of the “κ” method, obtaining the optimum value from measurement results within a region centering around a target power level, by conducting the measurement two (2) times upon the modulation factor.

Further, upon high-speed recording on the optical disk, mainly, there is applied a recording method of increasing the recording velocity directing from an inner periphery to an outer periphery thereof, being so-called a CAV (Constant Angular Velocity), and a laser power and strategy, for conducting the recording on an optical disk, can be obtained by adding compensation, which is obtained through calculation, to the optimum value, which is obtained through the test recording or writing within a region located between the inner periphery and the outer periphery of the disk.

For example, in the following Patent Document 3 is described a method of using the inner periphery test writing and the outer periphery test writing for the CAV recording, and with this method, as is shown in FIG. 15 attached herewith, the optimum recording powers are obtained, respectively, within an OPC area or region of the inner periphery of the disk and also an OPC area or region of the outer periphery thereof, a recording power (Power: on the vertical axis) to be turned ON at each of radial positions on the disk (on the horizontal axis) is obtained through the linear approximation thereof. Also, in CLV (Constant Linear Velocity) differing from the CAV recording, it is already known that, while obtaining the optimum recording powers by conducting the OPC on both the inner and the outer peripheries of the disk, at the same velocity, the recording power at each of the radial positions on the disk is obtained through the linear approximation, in the similar manner to the above-mentioned, when difference occurs between those powers obtained, too.

On the other hand, it is also necessary to add an ill influence upon recording due to unevenness of sensitivity within each of the optical disks, and/or an ill influence upon recording due to changes of the laser characteristics caused by changes of an ambient temperature thereof, and ordinarily, there is applied a method of confirming the recording quality during the recording, being called “walking OPC”, in particular, for the DVD. This is that, for example, as is shown in FIG. 16 attached herewith, after conducting the recording to a certain degree on the disk, the recording is stopped, once, for checking the recording quality (for example, the “β”, etc.) just before interruption of that recording operation, and thereby compensating or adjusting the recording power, in the contents thereof, and an example of such the walking OPC is disclosed in the following Patent Document 4, for example.
[Patent Document 1] Japanese Patent Laying-Open No. 2005-116027 (2005);
[Patent Document 2] Japanese Patent Laying-Open No. 2005-149538 (2005);
[Patent Document 3] Japanese Patent Laying-Open No. 2005-190525 (2005); and
[Patent Document 4] Japanese Patent Laying-Open No. 2004-234812 (2004).

By the way, in particular, for the disk having high density and large capacity, such as, the BD mentioned above, for example, it is required to determine the optimum power, more accurately or minutely.

However, to such the requirement, with the conventional “β” method mentioned above, though it is an easy method for estimating the recording quality, but it is inferior in the sensitivity of measurement in the vicinity of the optimum recording power (i.e., change of the “β” value is small to the value of recording power); therefore, it is difficult to achieve the measurement with high accuracy. Also, with the “κ” method according to the conventional technology, since the power is low in the vicinity of the linear approximation, then the accuracy of measurement is lowered down, i.e., the optimum values, which are obtained for the recording power, vary widely.

Further, with the method described in the Patent Document 1 mentioned above, there is necessity of a technology for measuring the values relating to the reflectivity, newly, and also with the method described in the Patent Document 2 mentioned above, there is a drawback that measurement must be conducted two (2) times for the “β” value.

Also, the method described in the Patent Document 3 mentioned above is weak against changes of temperature accompanying the changes of laser characteristics, and further, because of the linear approximation, an error is relatively large. Therefore, it is impossible to determine the optimum recording power with accuracy with respect to the disk having high density and large capacity, such as, the BD disk. Also, with the method described in the Patent Document 4 mentioned above, because of inferior sensitivity of “β” to the recording power in the vicinity of the optimum recording power, for the BD disks mentioned above, in particular, a part of the disks, being called “BD-R (writable only once)” and almost of the disks, being called “BD-RE (rewritable)”, there is pointed out a drawback that the present method cannot be applied therein. In addition thereto, for the blu-ray disk, as will be mentioned later, it is difficult to estimate the “β” value through the walking OPC, and therefore, a new method is necessitated for confirming the recording quality during the recording operation.

### BRIEF SUMMARY OF THE INVENTION

Then, according to the present invention, an object thereof is to provide a new technology, for determining the optimum recording power while confirming the recording quality during the recording operation, in particular, for the optical disk, of high density and large capacity, such as, the blu-disk, representatively, i.e., being inferior in the sensitivity of measurement in the vicinity of the optimum recording power and constructed with recording areas or regions, which are divided in a large number thereof by a predetermined information recording unit, i.e., RUB unit, and also provided with an area or region in a part of each of the recording areas, for enabling a free recording, having no relation with the recording of information.

However, before mentioning the present invention, in Japanese Patent Application No. 2005-347484 filed on Dec. 1, 2005, made by the same inventors, etc., it is already confirmed that the “β” sensitivity can be improved by applying a test signal determining an erase power (Pe) to be constant, and there is proposed a method for determining the optimum recording power with using this, and in addition thereto, there is also proposed a method for determining the optimum recording power, in particular, in case of applying the “κ” method adapting the modulation factor M as the index in common with.

And, according to the present invention, applying such the method for determining the optimum recording power, in particular, into the disk of high density and large capacity, such as, the BD disk, for example, and in that instance, as was mentioned above, with using the areas or regions, each being called APC area provided in a part of the recording areas, which are constructed with a large number of regions divided by the predetermined information recording unit (RUB), there is provide a new method for determining the optimum recording power while confirming the recording quality during the recording operation.

In more details, according to the present invention, first of all, there is provided 1. An optical disk apparatus for recording and reproducing data onto/from an optical disk, being constructed with recording regions divided into a plural number thereof, each being made of a predetermined information recording unit, and having a region, into which recording can be made irrespective of information recording, in a part of the recording region, comprising: a signal generator circuit, which is configured to produce a test signal; an optical pickup, which is configured to record the test signal through irradiation of a laser beam onto said optical disk, upon basis of the test signal supplied from said signal generator circuit, and to reproduce said test signal from said disk; a detector circuit, which is configured to obtain a “β” value indicative of asymmetry, from said test signal reproduced by said optical pickup; and a control circuit, which is configured to determine an optimal recording power Pwo from a recording power, a target “β” value of which is the “β” value obtained in said detector circuit, wherein said signal generator circuit produces the test signal, with changing a recording power Pw while fixing an erasing power Pe, and records said test signal into the region formed in a part of the recording regions of said optical disk, into which recording can be made irrespective of said information recording, thereby determining the optimal recording power Pwo for said optical disk.

Also, according to the present invention, also for accomplishing the object mentioned above, there is further provided a method for determining a recording power when recoding data onto an optical disk, being constructed with recording regions divided into a plural number thereof, each being made of a predetermined information recording unit, and having a region, into which recording can be made irrespective of information recording, in a part of the recording region, comprising the following steps of: recording a test signal onto the region, into which recording can be made irrespective of information recording, formed in a part of the recording region, with changing the recording power Pw while fixing the erasing power Pe; obtaining a “β” value indicative of asymmetry, with reproducing said signal recorded; and determining said optimal recording power Pwo from the from a recording power, a target “β” value of which is the “β” value obtained.

Further, according to the present invention, within the optical disk apparatus or the method for determining a recording power when recoding data onto an optical disk, described in the above, preferably, said signal generator circuit produces a second test signal, to make recording in the region formed in a part of the recording regions of said optical disk, into which recording can be made irrespective of said information recording, for determining the erasing power Pe to be used for said test signal, said detector circuit obtains a modulation factor indicative of an amplitude value from said second test signal, which is reproduced from said optical disk; and said signal generator circuit determines the erasing power Pe to be used in said test signal, upon basis of a result of M value of the modulation factor, which is obtained within said detector circuit. Or, preferably, said signal generator circuit determines a value Pe, being the erasing power Pe to be used in said test signal, in accordance with a recording condition recorded in advance on said optical disk, or a recording condition, which is determined by said apparatus in advance for said optical disk, thereby making the recording in the region formed in a part of the recording regions of said optical disk, into which recording can be made irrespective of said information recording, or said signal generator circuit produces the test signal, with using a value of approximately zero (0) as the erasing power Pe to be used in said test signal (Pe [symbol] 0), thereby making the recording in the region formed in a part of the recording regions of said optical disk, into which recording can be made irrespective of said information recording.

Or, according to the present invention, within the optical disk apparatus or the method for determining a recording power when recoding data onto an optical disk, described in the above, preferably, the optimal recording power Pwo for said optical disk is determined by equalizing a plural number of measurement values of the “β” value indicative of asymmetry on a reproduced signal of said test signal, which is recorded into the region formed in a part of the recording regions of said optical disk, into which recording can be made irrespective of said information recording.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an optical disk apparatus, according to an embodiment of the present invention;

FIG. 2 is a view for showing a waveform of record, schematically, for use in test recording;

FIGS. 3(a) to 3(c) are views for comparison between the method of the conventional art and the method according to the present invention, in particular, in relation to measurement of “β” value;

FIGS. 4(a) and 3(b) are views for explaining a measuring method of the “κ” method, which is applied in the present embodiment in common with;

FIG. 5 is a view for showing a flowchart of an optimum recording power method (1);

FIG. 6 is a view for showing a flowchart of an optimum recording power determining method (2);

FIG. 7 is a view for showing a flowchart of an optimum recording power determining method (3);

FIGS. 8(a) and (b) are views for explaining an optimum recording power determining method, according to the embodiment of the present invention;

FIG. 9 is a view for explaining an optimum recording power determining method, according to other embodiment of the present invention;

FIG. 10 is a view for explaining an optimum recording power determining method, according to further other embodiment of the present invention;

FIG. 11 is a view for explaining an optimum recording power determining method, according to further other embodiment of the present invention;

FIG. 12 is a view for explaining an optimum recording power determining method, according to further other embodiment of the present invention;

FIG. 13 is a view for explaining an optimum recording power determining method, according to further other embodiment of the present invention;

FIGS. 14(a) and 14(b) are views for explaining an optimum recording power determining method, according to further other embodiment of the present invention;

FIG. 15 is a view for explaining the an optimum recording power determining method, but according to the conventional technology; and

FIG. 16 is a view for explaining an optimum recording power determining method (walking OPC), according to the conventional technology.

### DETAILED DESCRIPTION OF THE INVENTION

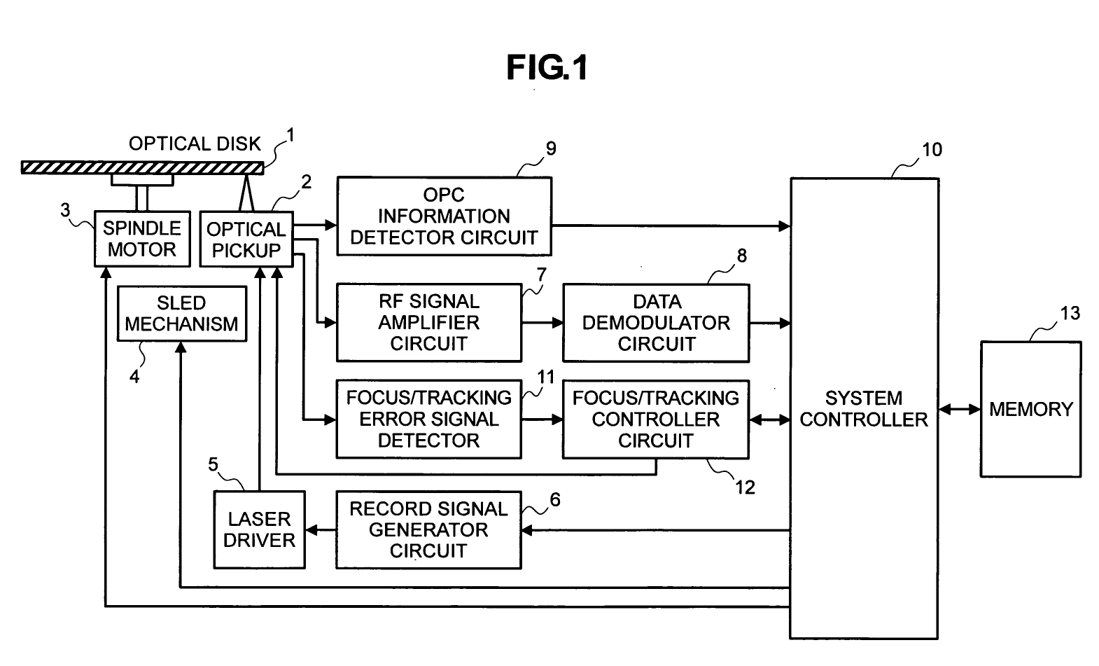

Hereinafter, embodiments according to the present invention will be fully explained by referring to the attached drawings. First of all, FIG. 1 attached herewith is a block diagram for showing brief structures of an optical disk apparatus, according to an embodiment of the present invention.

In this FIG. 1, the optical disk apparatus according to the present embodiment comprises, a spindle motor 3, for mounting an optical disk 1 of high density and large capacity, such as, the blu-disk, representatively, to rotationally drive it at a predetermined rotation speed, and an optical pickup 2, for irradiating a laser light generated from a semiconductor laser upon a recording surface (i.e., a lower surface in the figure) of the optical disk 1, which is rotationally driven by said spindle motor, thereby recording, or reproducing data and/or test signals. Also, on this optical pickup 2 is attached a sled mechanism 4, and due to the function of that mechanism, the optical pickup 2 mentioned above can move to a position of desired track upon the optical disk 1, which is rotationally driven at the predetermined rotation speed.

On the other hand, a recoding signal generator circuit 6 shown in the figure produces data or test a signal to be recorded, and a laser driver 5 controls a light emission power of the semiconductor laser, upon basis of the data or the test signal from that circuit. As a result of this, at the desired track position on the optical disk can be recorded the data or the test signal mentioned above.

Also, the optical pickup 2 reproduces the recorded data or the recorded test signal mentioned above from the optical disk 1, which is rotationally driven at the predetermined rotation speed. Further, this reproduction signal (i.e., RF signal) is amplified within a RF signal amplifier circuit 7, and demodulated within a data demodulator circuit 8, thereby to be outputted as reproduced data (information).

Further, an OPC information detector circuit 9 in the figure obtains OPC information (quality, such as, the “β” value, etc.) from a result of reproduction of the test signal mentioned above. Also, within a control area or region on the optical disk 1, there is recorded, in advance, a recording condition, including the recording power determination, for that optical disk (hereinafter, “strategy information”), as control data, and it can be used for determining the optimum recording condition through readout thereof.

And, a focus tracking error signal detector 11 detects a level of the reproduction signal (RF signal), for example, and thereby producing focus error and tracking error signals. A focus/tracking controller circuit 12 performs focus control and tracking control of the optical pickup 2, upon basis of those error signals. Also, a system controller (controller circuit) 10 performs controls upon the entire of the apparatus, including the recording power determining steps (OPC) therein, and it stores programs and data for those within a memory 13.

In the structures mentioned above, in particular, mentioning about the determination of the optimum recording power, within the recoding signal generator circuit 6 is reproduced a test signal changing the recording power, etc., in a step-like manner, by referring to the strategy information, and this signal is recorded on trial (i.e., test recording) in the OPC region of the optical disk 1. Next, the test signal is reproduced by the optical pickup 2, so as to make measurement on the qualities of the waveforms reproduced (i.e., the modulation factor and the asymmetry, etc.) within the OPC information detector circuit 9. The system controller (controller circuit) 10 determines the optimum value of the recording power upon basis of the measurement results in relation to the qualities of those reproduction waveforms.

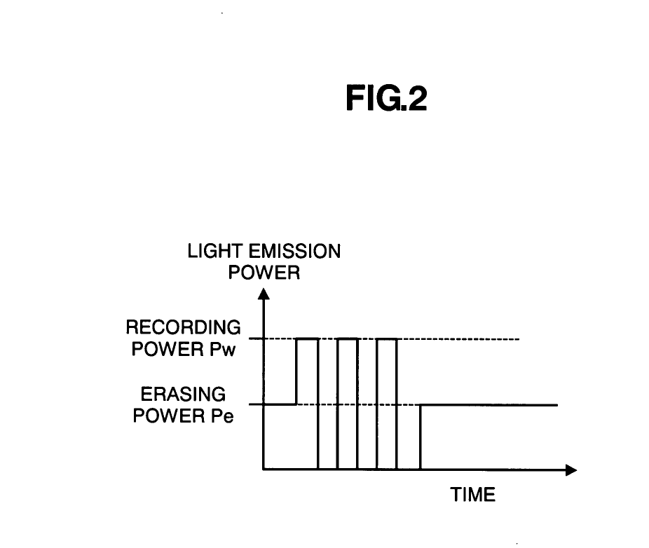

Following to the above, explanation will be given on a method for determining the optimum recording power, according to the present embodiment. Thus, FIG. 2 attached herewith is a view for showing the recording waveforms for use of test recording, schematically. The vertical axis indicates a level of light emission power, a mark “Pw” the recording power “wp”, and “Pe” the erasing power, respectively. The recording power “Pw” is changed in the step-like manner within a predetermined range. In that instance, the erasing power “Pe” is fixed (but, the “Pe” is changed together with the recording power “Pw” in a part of the steps, so that a ratio Pw/Pe comes to be constant).

Also, within the present embodiment, the following indexes are used when estimating the qualities of the reproduction waveforms. A first one is the “β” value indicative of the asymmetry of the reproduction signal, in particular, in positive/negative amplitudes thereof (i.e., the “β” method). Other one is the modulation factor “M” presenting a ratio between amplitude of the reproduction waveform and the maximum (or saturation) amplitude thereof. Conventionally, while determining a target value (“Target”) of the “β” value or the “M” value, the optimum recording power Pwo is determined upon basis of the power Pw, the target value of which can be obtained; however, according to the present embodiment, an improvement is made on this.

### <“β” Method>

Thus, first of all, it is assumed that there is applied the “β” method for estimating the quality upon basis of the “β” value, in order to determine the optimum recording power. However, with the “κ” method applying the modulation factor “M” as the index, since the modulation factor “M” is measured upon the basis of the peak level (an absolute value) of the RF amplitude, then in particular, signals mixing therein from the other layer (already recorded) within the medium of two (2) layers give ill influences upon the modulation factor, in the form of an offset, and it is difficult to escape from this. On the contrary to that, with this “β” method, since the “β” value can be obtained from a ratio between the difference between the peak level and a DC level (a relative value) and the RF amplitude, there no ill influence due to the offset from the other layer. Furthermore, according to the present embodiment, for improving the accuracy thereof, it is characterized in that the erasing power “Pe” of the test signal is fixed.

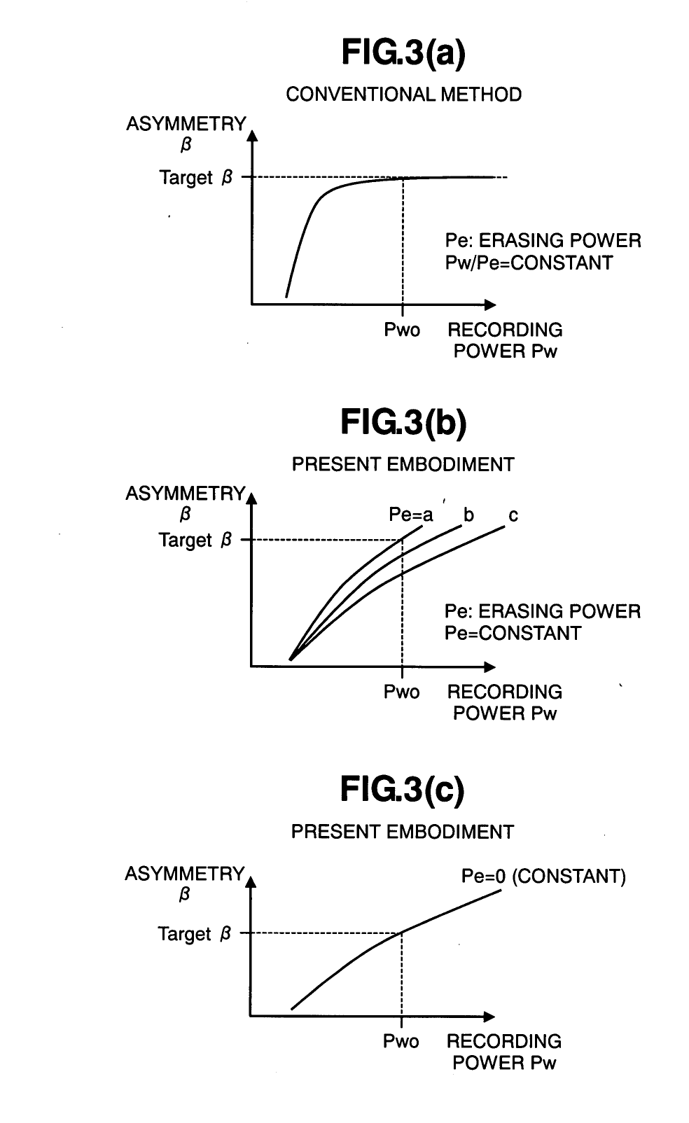

FIGS. 3(a) to 3(c) attached herewith are views for comparison between the conventional method and the method according to the present embodiment, in particular, in relation to measurement of this “β” value. First, FIG. 3(a) shows the conventional method, wherein the erasing power “Pe” is changed so that the ratio Pw/Pe comes to be constant, and thereby measuring the “β” value. However, with this method, an inclination or slope of characteristic curve is steep in a low power region, on the other hand, the slope thereof comes to be gentle in a high power region where the target value “Target_β” can be obtained. In particular, in case when requiring fine or minute adjustment, such as, the BD disk mentioned above, for example, it is necessary for the characteristic curve to have an appropriate inclination or slope, but with such the characteristic of the recording power as is shown in FIG. 3(a), it is difficult to obtain the optimum value Pwo thereof, with high accuracy.

On the contrary to this, FIG. 3(b) shows the “β” value, being measured while changing only the Pw but fixing the erasing power Pe. However, herein, there is shown a characteristic curve, which can be obtained in case when setting the Pe at a value, being lower than an ordinary erasing power Pe, a, b, c (a>b>c). Thus, with this method, the curve has an appropriate inclination in the high power region (i.e., being high in the measuring sensitivity), and it is possible to obtain the optimum power Pwo with respect to the “Target_β”, with high accuracy. However, depending upon a manner of applying the Pe value mentioned above, the “β” curve may be shifted, and there is a possibility that the value is shifted of the optimum value Pwo obtained. Therefore, it is necessary to obtain the Pe value, correctly, in advance. Further, FIG. 3(c) shows the case where this Pe value is fixed at “0”. In this case, although the “β” curve shows an appropriate inclination, but in that instance, it is necessary to make compensation accompanying with the fact of setting the Pe value to “0” (for example, compensation of “Target_β”).

However, when determining the value of the optimum value Pwo, it is also possible, not only to shift the value of recording power for obtaining the target value “Target_β” to the optimum value Pwo as it is, but also to obtain the optimum value Pwo by multiplying a predetermined coefficient onto the value of recording power for obtaining the target value “Target_β”, other than that, for example.

Hereinafter, explanation will be made on the details of the steps of the optimum recording power determining method, fixing the erasing power Pe, by referring to a flowchart shown in FIG. 5.

<Determination Method 1>

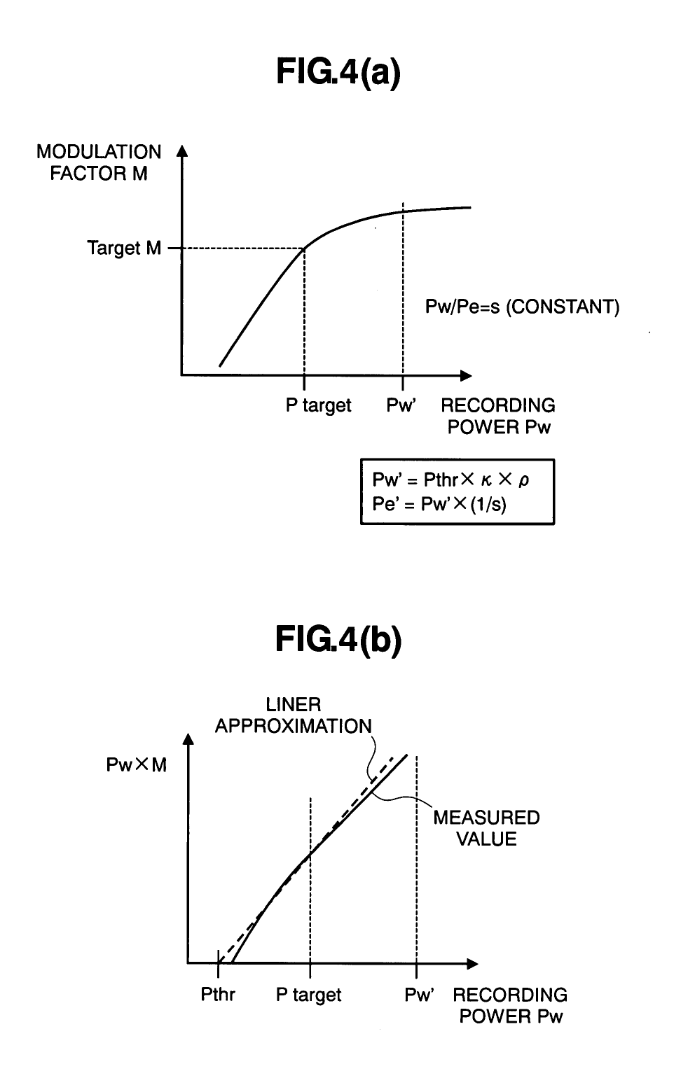

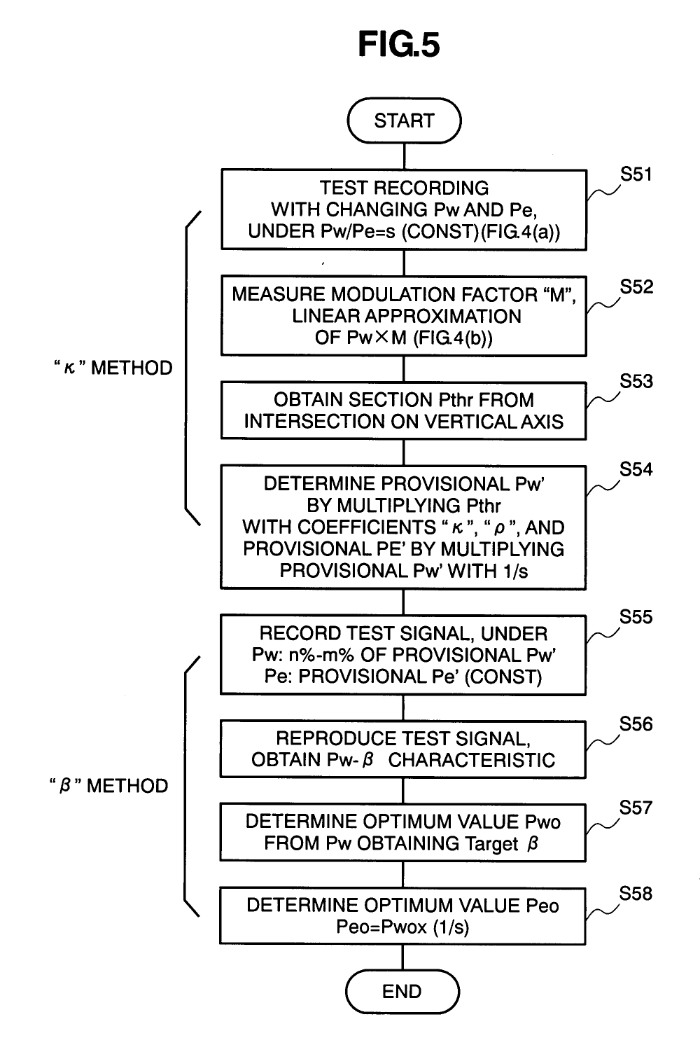

FIG. 5 shows the flowchart of the optimum recording power determining method, in particular, in case when applying the “κ” method indexing the modulation factor “M”, in common with, in order to obtain Pe to be fixed. However, FIGS. 4(a) and 4(b) are views for explaining a measuring method of the “κ” method to be applied in common with.

### <“κ” Method>

In steps S51 to S54, a preliminary or provisional Pw (Pw′) and or a preliminary or provisional Pe (Pe′) are determined, in accordance with the “κ” method. Thus, in a step S51, under the condition that Pw/Pe=s (already known coefficient, being constant), the test recoding is conducted while changing the Pw and the Pe, thereby measuring the modulation factor “M” (FIG. 4(a)). As the coefficient “s” in that instance may be used the strategy information contained in the control data of that optical disk or the strategy information, which is stored in the memory 13 after being determined by an apparatus maker for that optical disk. In a step S52, a linear approximation is made on a relationship between the product Pw and M (Pw×M) and the Pw, within such vicinity of the Pw (“Ptarget”) that the modulation factor “M” reaches to the target value “Target_M” (FIG. 4(b)). In a step S53, the Pw value at a point of intersection with the horizontal axis (Pw×M=0) is set to be a section Pthr. In a step S54, determination is made upon the provisional Pw′, through multiplication of the Pthr by predetermined coefficients “κ” and “ρ” (either one is already known), and also the provisional Pe′ is determined by multiplying 1/s thereon.

Next, in steps S55 to S58, the optimum values Pwo and Peo are determined, in accordance with the “β” method. First, in a step S55, recoding of the test signal is conducted with changing the Pe around the Pw′ within a predetermined range n %-m %, while fixing the Pe to the provisional Pe′. In a step S56, the test signal is reproduced, and the OPC information is obtained therefrom, i.e., the “β” value (asymmetry) herein. In a step S57, the optimum value Pwo is determined from such the Pw that the “β” value comes to the “Target_β”. And, in a step S58, the optimum value Peo is determined by multiplying 1/s onto Pwo.

According to the method mentioned above, the possibility is extremely high, that the value Pe′ obtained with the “κ” method is used, as the Pe value when measuring the “β”, therefore it is possible to determine the recording power, correctly. The optimal Pe value differs depending upon a type or a kind of that disk, and also fluctuates upon variation of the drive and/or temperature condition thereof, however, with this method, there can be obtained an effect of enabling stable determination, always, irrespective of those changes.

<Determination Method 2>

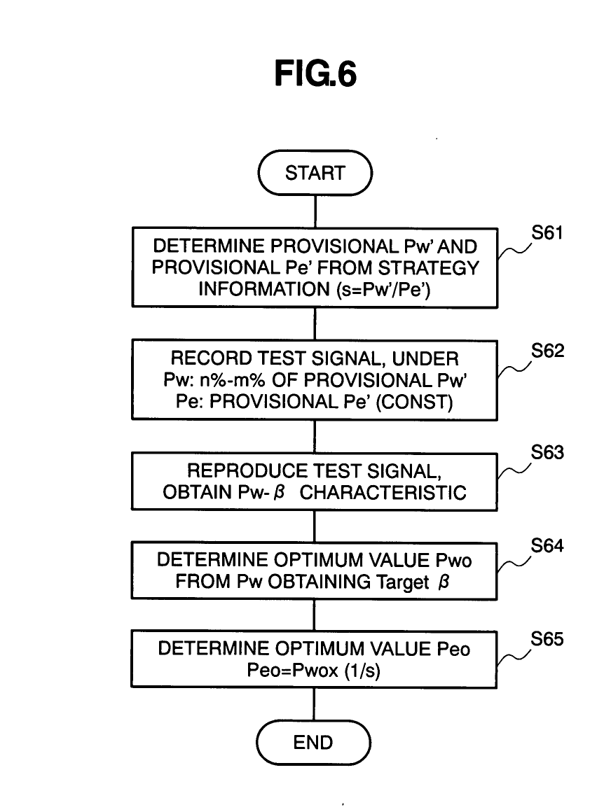

FIG. 6 is a flowchart of the optimum recording power determining method, in particular, when referring to the strategy information of that disk, for the purpose of obtaining the Pe to be fixed.

In a step S61, the strategy information is read out from the control data of the optical disk or the memory 13 of the apparatus, so as to determine the provisional Pw′ and Pe′ from the values described therein, and the ratio is determined Pw′/Pe′=s. In a step S62, the test signal is recorded with changing the Pw around the provisional Pw′ within the predetermined range n %-m %, while fixing the Pe to the provisional Pe′. In a step S64, the optimum value Pwo is determined from such the Pw that the “β” value comes to the “Target_β”. And, in a step S65, the optimum value Peo is determined by multiplying 1/s onto Pwo.

With this method, the steps for determining the power can be shortened or reduced. Thus, it is possible to omit the steps of the “κ” method (i.e., S51-S54), which are executed in the <Determination Method 1> mentioned above, and thereby enabling to shorten or reduce the time for determining.

<Determination Method 3>

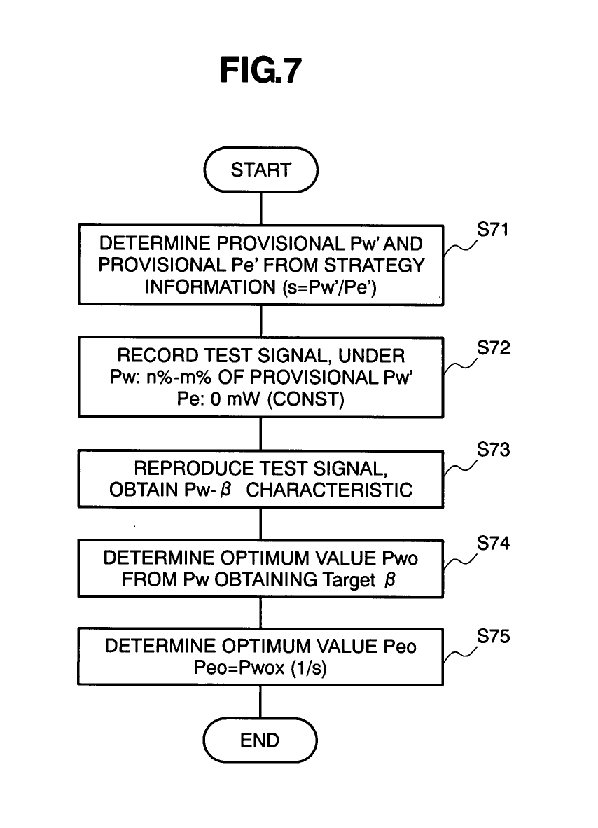

FIG. 7 is a view for showing a flow of the optimum recording power determining method, in particular, in case when fixating Pe=0, as is shown in FIG. 3(c).

In a step S71, the strategy information is read out from the control data of the optical disk or the memory 13 of the apparatus, so as to determine the provisional Pw′ and Pe′ from the values described therein, and the ratio is determined Pw′/Pe′=s. In a step S72, the test signal is recorded with changing the Pw around the provisional Pw′ within the predetermined range n %-m %, while fixing the Pe to zero (0). However, Pe=0 mentioned herein has no intention to limit to zero, restrictively, but has a meaning to be close to zero (0), approximately, comparing to the other values. In a step 73, the test signal is reproduced, thereby obtaining the “β” value. In a step S74, the optimum value Pwo is determined from such the Pw that the “β” value comes to the “Target_β”. However, in this case, since compensation is made on the shifting of “β” curve due to the presumption, Pe=0, a compensation value is used, as the value of the “Target_,”. In a step S75, the optimum value Peo is determined by multiplying 1/s onto Pwo.

With this method, the “β” curve to be measured is only one (1) piece, and the optimum value obtained from this is independent upon the variation of the apparatus and/or the temperature condition thereof, and therefore a stable result can be expected. Also, the necessary measurement is only a step of one (1) time with the “β” method, and for that reason, it is possible to shorten or reduce the time, greatly.

As was mentioned above, accordance to the optimum recording power determining method mentioned above, for determining the optimum recording power, there is applied the “β” method of obtaining the “β” value with changing the recording power Pw while fixing the erasing power Pe, or is applied the “κ” method of applying the modulation factor “M” as the index. And, according to the present invention, with applying those methods therein, it is possible to determine the optimal recording power with confirming the recording quality during when recording, in particular, also for the optical disk having high density and large capacity, such as, the blu-ray disk, representatively, for example. In more details thereof, it is applied onto the optical disk having high density and large capacity, such as, the blu-ray disk, representatively, for example, and in that instance, in particular, with using the area or region called “APC area” provided in a part of the recoding areas, which is constructed with the areas or regions divided a large number thereof by a unit of the predetermined information recording unit (RUB), being unique to such the disk, it is possible to provide a new method for determining the optimal recording power with confirming the recording quality during when recording.

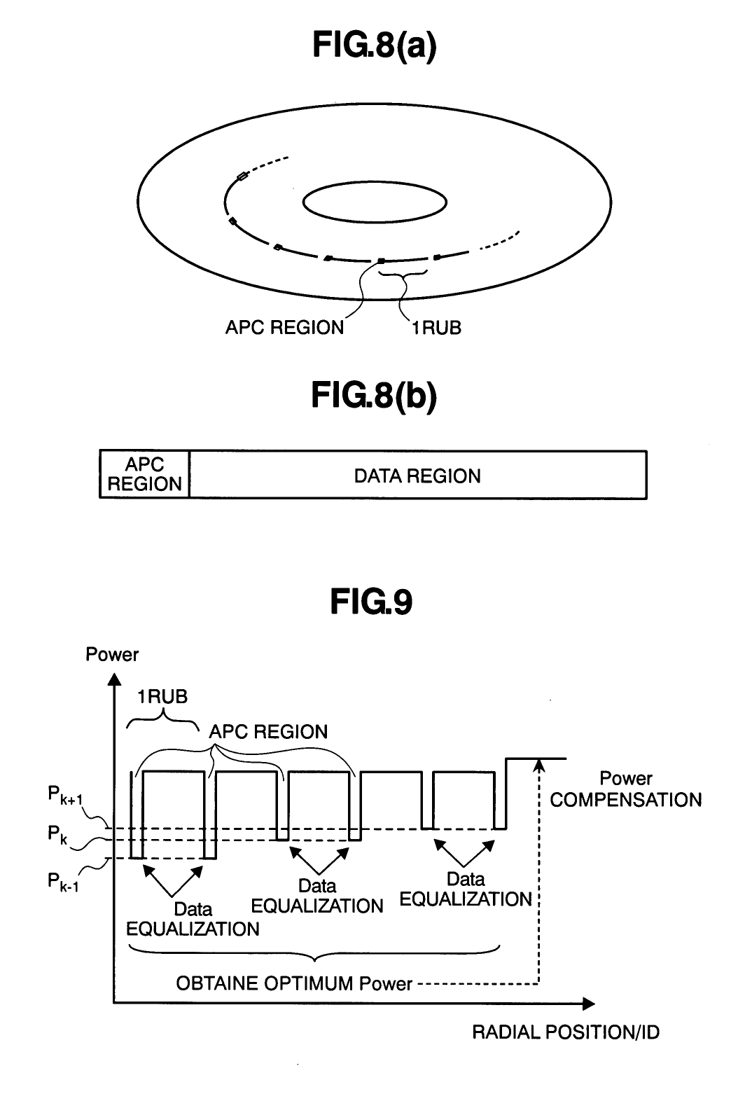

FIG. 8(a) shows the information recording units (RUB), which are formed in a large number thereof, upon the recording surface of the blu-ray disk (BD) mentioned above, and at a head portion thereof is provided the above-mentioned APC area or region, by a unit 5 wbs (wobbles), as is shown in FIG. 8 (b). Then, according to the present invention, by paying attention onto this APC region, it is possible to provide a new method for determining the optimal recording power while confirming the recoding quality during when recording. However, this APC region is short, i.e., 5 wbs (wobbles) in the data length thereof, and for that reason, the optimum recording power determining method mentioned above is applied, according to a method, which will be mentioned below. Thus, the APC region is very short, i.e., 5 wbs, so that the data obtainable through measurement is small by only one (1) piece of the APC region, and also the value thereof varies widely. Then, with using a plural number of APC regions, a sufficient amount of measurement data can be obtained through the above-mentioned optimum recording power determining method, and thereby achieving the method for obtaining the optimum recording power having less variation thereof.

Firstly, FIGS. 9 to 11 show the optimum recording power determining method, according to the one embodiment of the present invention. In this example, the measurement data is obtained by implementing the optimum recording power determining method with the “β” method or the “κ” method mentioned above, within the plural number of APC regions mentioned above, and an averaged value thereof is obtained. Thus, with applying any one of the determining methods mentioned above, determination is made on the optimal recording power. However, in those figures, the vertical axis indicates a laser power, the horizontal axis a radial position of RUB on the recording surface of the blu-ray disk (BD) mentioned above, with an aid of an ID number of each RUB.

Thus, with the optimum recording power determining method shown in FIG. 9 attached herewith, with using the plural number of APC regions, each locating in a part of the regions covering over a plural number of RUBs, recording is conducted while changing the recording power thereof, sequentially (for example, . . . Pₖ₋₁, Pₖ, Pₖ₊₁ . . . ), and thereafter, the measurement data is obtained, collectively, in a bundle of them, through the above-mentioned optimum recording power determining method. In that instance, the plural number of data is obtained for each of the changing recording powers, in this example, and an averaged value of those is obtained (i.e., equalization of data). Thus, this enables a measurement with less variation, and thereby obtaining the optimum recording power (the optimum Power) with certainty. However, after obtaining this optimum recording power (the optimum Power), the optical disk apparatus compensates the optimum recording power in accordance with the optimum Power obtained (i.e., Power compensation).

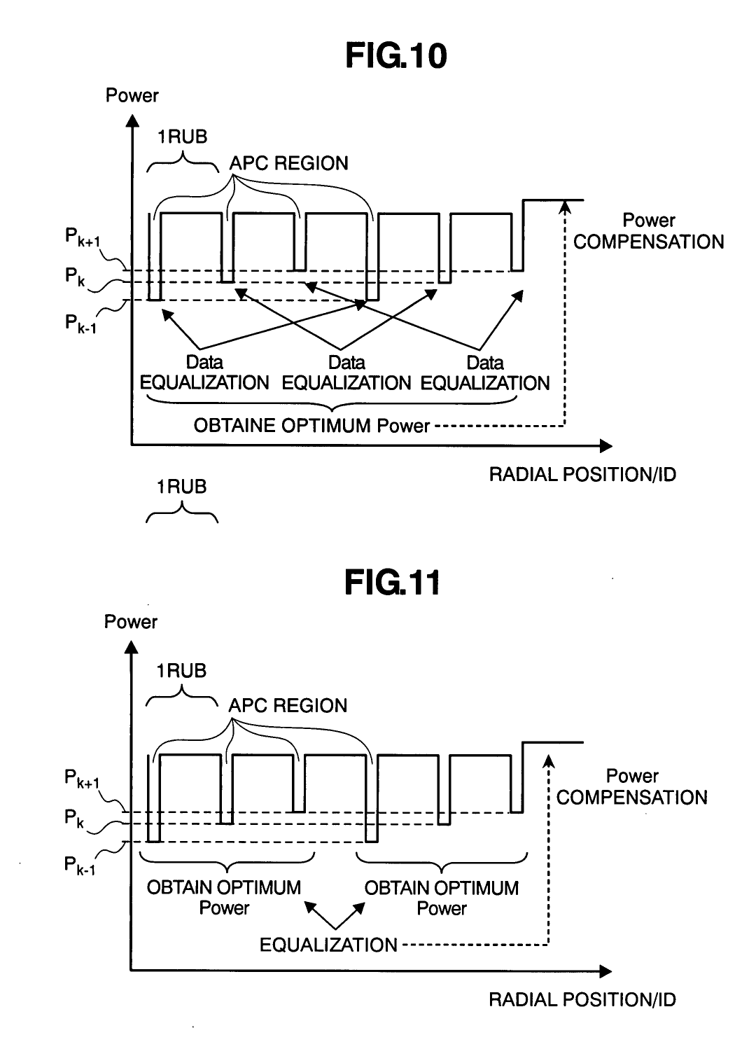

Also, with the optimum recording power determining method shown in FIG. 10 attached herewith, while changing the recording powers, sequentially, for a set of APC regions neighboring with one another (for example, . . . Pₖ₋₁, Pₖ, Pₖ₊₁ . . . ), recording is conducted within a plural number of sets of APC regions, and thereafter, the measurement data is obtained, collectively, in a bundle of them, through the optimum recording power determining method mentioned above. In that instance, the data is obtained within the APC regions separating from one another, in this example, and an averaged value of those is obtained (i.e., equalization of data), thereby enabling the measurement with less variation, in the similar manner to the above. And, therefore, this is suitable for determining the optimum recording power, in particular, on the disk showing an uneven characteristic on the recording surface thereof. Further, in FIG. 11 attached herewith is shown a method for obtaining the average of the optimum recording powers (optimum Powers), each of which is obtained within the APC region of each of the sets, in that instance, and with this, it is also possible to obtain an effect similar to that mentioned above.

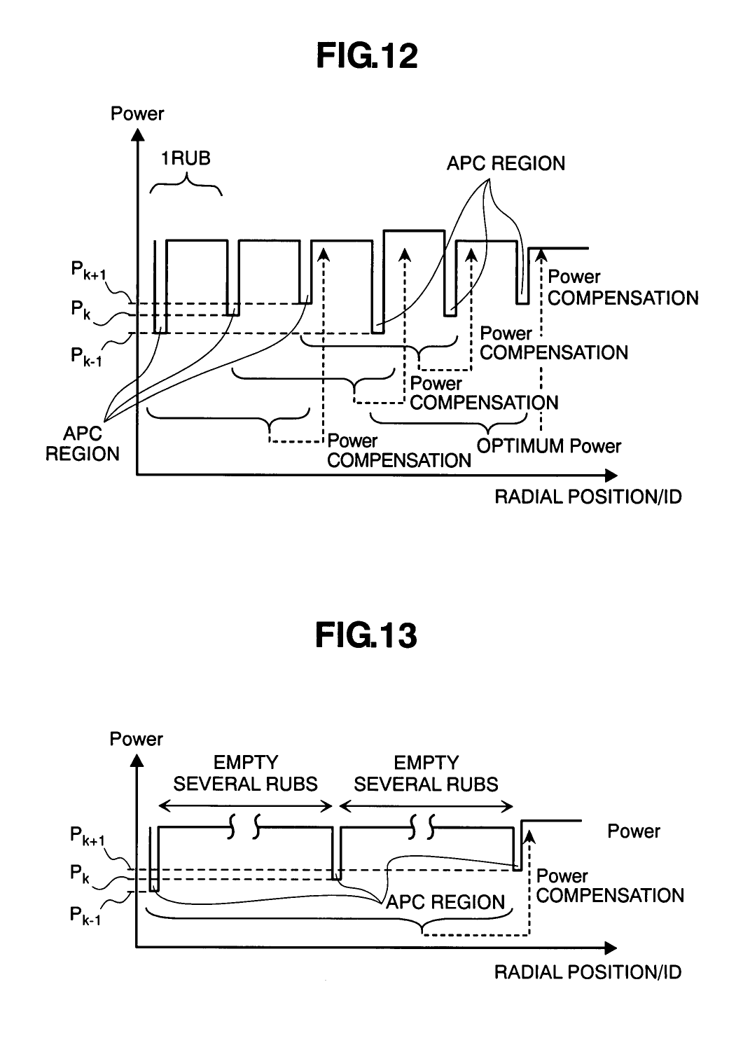

Further, FIG. 12 attached herewith shows other method, and with this optimum recording power determining method, the optimum recording power (the optimum Power) is obtained to conduct the Power compensation, while changing the recording powers in the plural number of APC regions, sequentially (for example, . . . Pₖ₋₁, Pₖ, Pₖ₊₁ . . . ), and thereafter, the Power compensation is conducted while changing the recording power, sequentially (for example, . . . Pₖ₋₁, Pₖ, Pₖ₊₁ . . . ). In that instance, every time when conducting the recording in the next one (1) piece of APC region (in this case, recording with power Pₖ₋₁), an averaged value is obtained from the data previously measured, but removing one (1) of data (in this instance, the recording with the first power Pₖ₋₁) from that (i.e., data equalization), and then the optimum recording power determining method is conducted upon the following RUBs therefrom. With this method, as is apparent from the figure, since the Power compensation can be made on the continuing RUBs, sequentially, it is suitable, in particular, for determining the optimal recording power while confirming the recording quality during when recording, successively.

In addition thereto, with the optimum recording power determining method shown in FIG. 13 attached herewith, but differing from those mentioned above, the Power compensation is conducted on APC region in a part of the unit, including a plural number of RUBs neighboring with, in other words, emptying an area or region of several RUBs between the APC regions, while changing the recording power, sequentially (for example, . . . Pₖ₋₁, Pₖ, Pₖ₊₁ . . . ), in the similar manner to the above, and thereafter, measurement data is obtained from those regions, collectively in a lump. As a result thereof, by obtaining the averaged value from the measurement data obtained (i.e., data equalization), it is possible to achieve the measurement with less variation, and also with this method, it is possible to conduct the determination of the optimum recording power, more quickly.

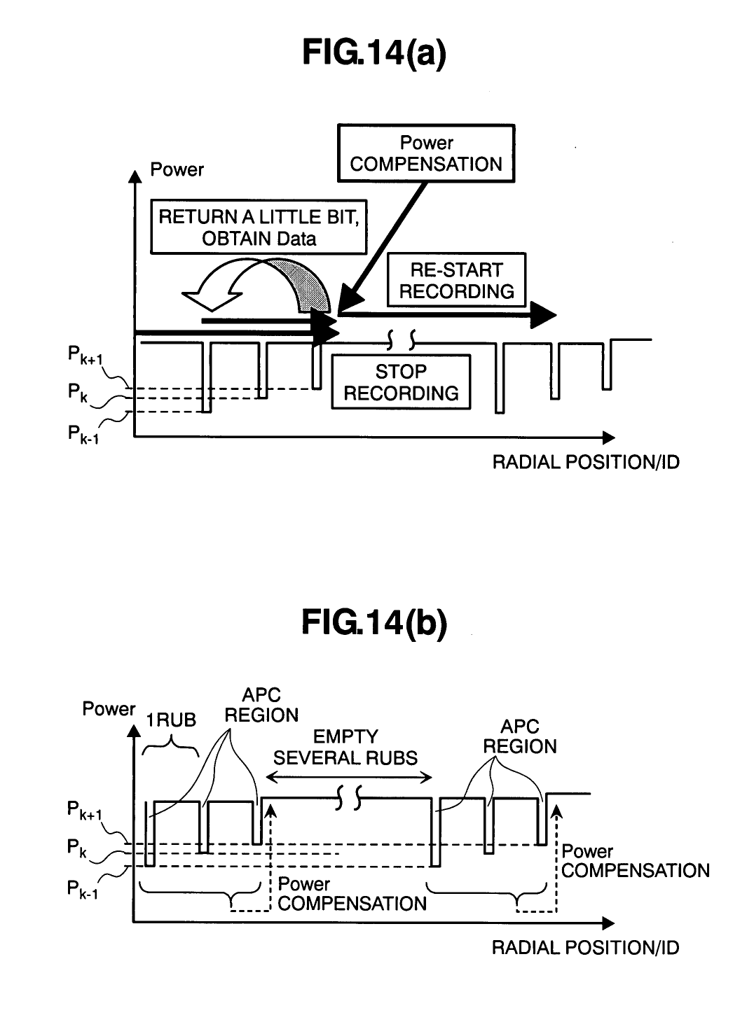

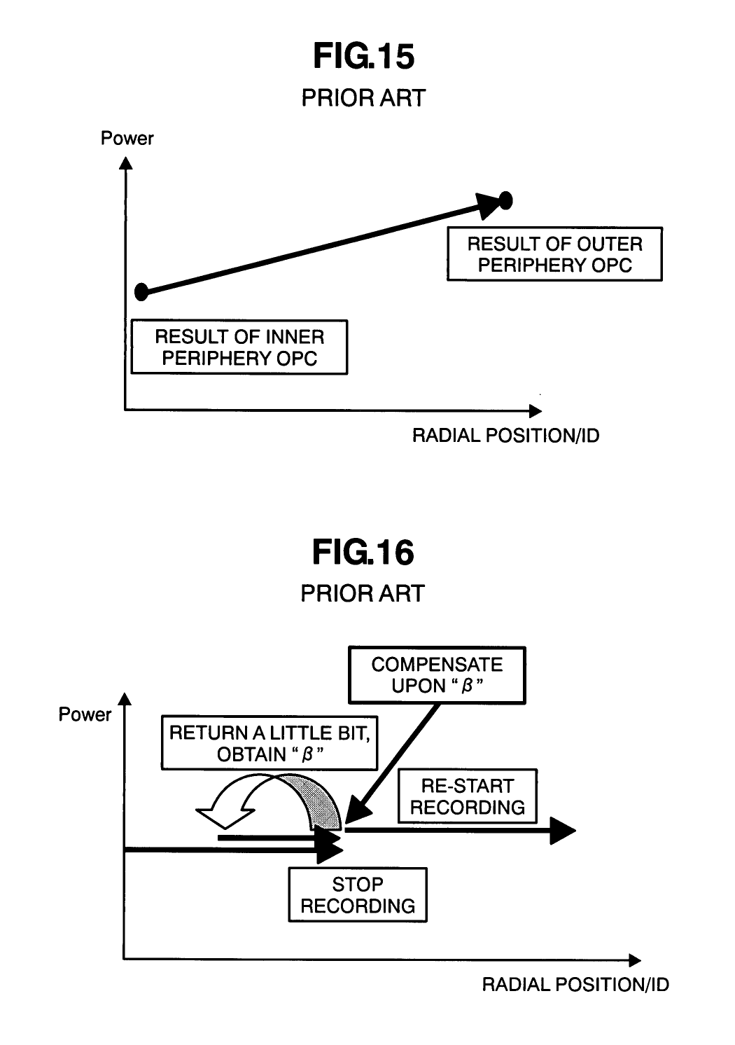

And, in FIGS. 14(a) and 14(b) attached herewith is shown further other method, and with this optimum recording power determining method, in similar manner to the so-called walking OPC, the measurement data is obtained, collectively in a lump, while changing the recording power, sequentially (for example, . . . Pₖ₋₁, Pₖ, Pₖ₊₁ . . . ), for the plural number of APC regions, and thereafter, returning by that plural number of APC regions. And, the Power compensation is made upon basis of the measurement data obtain therewith, and thereafter, recording is started, again. However, the recording for determining the optimum recording power is interrupted (stopped), i.e., the operations mentioned above are repeated (re-started), again, while emptying the region of several RUBs between them. With this method, it is possible to determine the optimum recording power, with certainty and more quickly, for a predetermined regions or areas, in similar manner to that walking OPC.

Thus, with those various optimum recording power determining methods mentioned above, using the various kinds of methods mentioned above therein, as the method for determining the recording power when measuring “β”, it is possible to determine the optimal recording power with confirming the recording quality during when recording, in particular, when applying in the optical disk having high density and large capacity, such as, the blu-ray disk, representatively, for example. However, herein, detailed explanation was given, in particular, on the method for obtaining “β” while keeping Pe constant, but it should not restricted only thereto, according to the present invention, and it is also possible to achieve with using the “β” method, “γ” method or “κ” method, etc., other than that.

As was mentioned above, according to the present invention, there can be achieved a superior effect of providing the optical disk apparatus and the method for determining a recording power, enabling to determine the optimal recording power while confirming the recording quality during when recording, even for the optical disk having high density and large capacity, such as, the blu-ray disk, representatively, for example.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disk apparatus for recording and reproducing data onto/from an optical disk, being constructed with recording regions divided into a plural number thereof, each being made of a predetermined information recording unit, and having a region, into which recording can be made irrespective of information recording, in a part of the recording region, comprising:
a signal generator circuit, which is configured to produce a test signal;
an optical pickup, which is configured to record the test signal through irradiation of a laser beam onto said optical disk, upon basis of the test signal supplied from said signal generator circuit, and to reproduce said test signal from said disk;
a detector circuit, which is configured to obtain a value indicative of asymmetry, from said test signal reproduced by said optical pickup; and
a control circuit, which is configured to determine an optimal recording power Pwo from a recording power, a target “β” value of which is the “β” value obtained in said detector circuit, wherein
said signal generator circuit produces the test signal, with changing a recording power Pw while fixing an erasing power Pe, and
records said test signal into the region formed in a part of the recording regions of said optical disk, into which recording can be made irrespective of said information recording, thereby determining the optimal recording power Pwo for said optical disk.

2. The optical disk apparatus, described in the claim 1, wherein
said signal generator circuit produces a second test signal, to make recording in the region formed in a part of the recording regions of said optical disk, into which recording can be made irrespective of said information recording, for determining the erasing power Pe to be used for said test signal,
said detector circuit obtains a modulation factor indicative of an amplitude value from said second test signal, which is reproduced from said optical disk; and
said signal generator circuit determines the erasing power Pe to be used in said test signal, upon basis of a result of M value of the modulation factor, which is obtained within said detector circuit.

3. The optical disk apparatus, described in the claim 1, wherein
said signal generator circuit determines a value Pe, being the erasing power Pe to be used in said test signal, in accordance with a recording condition recorded in advance on said optical disk, or a recording condition, which is determined by said apparatus in advance for said optical disk, thereby making the recording in the region formed in a part of the recording regions of said optical disk, into which recording can be made irrespective of said information recording.

4. The optical disk apparatus, described in the claim 1, wherein
said signal generator circuit produces the test signal, with using a value of approximately zero (0) as the erasing power Pe to be used in said test signal (Pe [symbol] 0), thereby making the recording in the region formed in a part of the recording regions of said optical disk, into which recording can be made irrespective of said information recording.

5. The optical disk apparatus, described in the claim 1, wherein the optimal recording power Pwo for said optical disk is determined by equalizing a plural number of measurement values of the “β” value indicative of asymmetry on a reproduced signal of said test signal, which is recorded into the region formed in a part of the recording regions of said optical disk, into which recording can be made irrespective of said information recording.

6. The optical disk apparatus, described in the claim 2, wherein the optimal recording power Pwo for said optical disk is determined by equalizing a plural number of measurement values of the “β” value indicative of asymmetry on a reproduced signal of said test signal, which is recorded into the region formed in a part of the recording regions of said optical disk, into which recording can be made irrespective of said information recording.

7. The optical disk apparatus, described in the claim 3, wherein the optimal recording power Pwo for said optical disk is determined by equalizing a plural number of measurement values of the “β” value indicative of asymmetry on a reproduced signal of said test signal, which is recorded into the region formed in a part of the recording regions of said optical disk, into which recording can be made irrespective of said information recording.

8. The optical disk apparatus, described in the claim 4, wherein the optimal recording power Pwo for said optical disk is determined by equalizing a plural number of measurement values of the “β” value indicative of asymmetry on a reproduced signal of said test signal, which is recorded into the region formed in a part of the recording regions of said optical disk, into which recording can be made irrespective of said information recording.

9. A method for determining a recording power when recoding data onto an optical disk, being constructed with recording regions divided into a plural number thereof, each being made of a predetermined information recording unit, and having a region, into which recording can be made irrespective of information recording, in a part of the recording region, comprising the following steps of:
recording a test signal onto the region, into which recording can be made irrespective of information recording, formed in a part of the recording region, with changing the recording power Pw while fixing the erasing power Pe;
obtaining a “β” value indicative of asymmetry, with reproducing said signal recorded; and
determining said optimal recording power Pwo from the from a recording power, a target “β” value of which is the “β” value obtained.

10. The method for determining a recording power, as described in the claim 9, wherein
recording is made in the region formed in a part of the recording regions of said optical disk, into which recording can be made irrespective of said information recording, for determining the erasing power Pe to be used for said test signal;
a modulation factor is obtained, indicative of an amplitude value from said second test signal, which is reproduced from said optical disk; and
determining is made on the erasing power Pe to be used in said test signal, upon basis of a result of M value of the modulation factor.

11. The method for determining a recording power, as described in the claim 9, wherein determining is made on a value Pe, being the erasing power Pe to be used in said test signal, in accordance with a recording condition recorded in advance on said optical disk, or a recording condition, which is determined by said apparatus in advance for said optical disk, thereby making the recording in the region formed in a part of the recording regions of said optical disk, into which recording can be made irrespective of said information recording.

12. The method for determining a recording power, as described in the claim 9, wherein the test signal is produced, with using a value of approximately zero (0) as the erasing power Pe to be used in said test signal (Pe [symbol] 0), thereby making the recording in the region formed in a part of the recording regions of said optical disk, into which recording can be made irrespective of said information recording.

13. The method for determining a recording power, as described in the claim 9, wherein the optimal recording power Pwo for said optical disk is determined by equalizing a plural number of measurement values of the “β” value indicative of asymmetry on a reproduced signal of said test signal, which is recorded into the region formed in a part of the recording regions of said optical disk, into which recording can be made irrespective of said information recording.

14. The method for determining a recording power, as described in the claim 10, wherein the optimal recording power Pwo for said optical disk is determined by equalizing a plural number of measurement values of the “β” value indicative of asymmetry on a reproduced signal of said test signal, which is recorded into the region formed in a part of the recording regions of said optical disk, into which recording can be made irrespective of said information recording.

15. The method for determining a recording power, as described in the claim 11, wherein the optimal recording power Pwo for said optical disk is determined by equalizing a plural number of measurement values of the “β” value indicative of asymmetry on a reproduced signal of said test signal, which is recorded into the region formed in a part of the recording regions of said optical disk, into which recording can be made irrespective of said information recording.

16. The method for determining a recording power, as described in the claim 12, wherein the optimal recording power Pwo for said optical disk is determined by equalizing a plural number of measurement values of the “β” value indicative of asymmetry on a reproduced signal of said test signal, which is recorded into the region formed in a part of the recording regions of said optical disk, into which recording can be made irrespective of said information recording.
